(19) United States
(12) Patent Application Publication
(10) Pub. No.: US 2002/0169902 A1
(43) Pub. Date: Nov. 14, 2002

(54) Data processor

(75) Inventors: Michihiro Horiuchi, Chitose (JP); Kateumi Iwata, Kodalra (JP)

Correspondence Address: Stanley P. Fisher, Reed Smith LLP, Suite 1400, 3110 Fairview Park Drive, Falls Church, VA, 22042-4503, US

(73) Assignee: Hitachi, Ltd.

(21) Appl. No.: 10/086,376

(22) Filed: Mar. 4, 2002

(30) Foreign Application Priority Data
May 14, 2001 (JP) 2001-142497

(51) Int. Cl. G06F 13/12

(52) U.S. Cl. 710/69

(57) ABSTRACT

A data processor having: a peripheral circuit for selecting one of input terminals such as input channels, processing input data from the selected input terminal, requesting the transfer of the processing result, and outputting identification information (CH2 to CH0) which permits the identification of the selected input terminal; and a data transfer control circuit comprising a destination address register (DAR) with its low-order bits variable according to the identification information from the peripheral circuit, whereby the low-order bits of destinations can be controlled by the peripheral circuit in the transfer control circuit. The peripheral circuit is not required to comprise data registers for storing an input data processing result for each input terminal in one-to-one correspondence with the input terminals.

### BACKGROUND OF THE INVENTION

1. Field of the Invention

The present invention relates to a data processor with data transfer control circuits such as a direct memory access controller (DMAC) and a data transfer controller(DTC), as well as peripheral circuits such as an analog-to-digital converter and a timer counter, and more particularly to a technology effective in decreasing the number of data registers in peripheral circuits incorporated into a single-chip microcomputer.

2. Description of the Related Art

An analog-to-digital converter incorporated into a single-chip microcomputer usually has a plurality of analog input channels, converts analog signals input from the selected analog input channel to digital data, and stores the resultant digital data in its data registers adapted for the analog input channels. In other words, a plurality of data registers are provided corresponding to the number of the analog input channels. The analog-to-digital converter is similar to a free running counter with its input capture registers provided in a one-to-one correspondence with input events in that the data registers of the analog-to-digital converter are individually provided.

The analog-to-digital converter sends a data transfer request to a direct memory access controller when converted data is stored in its data register. In response to this request, the direct memory access controller performs transfer controls to transfer the converted data in the data resister to other devices such as a memory using the corresponding data transfer channel for which data transfer control conditions have been set. If data conversion is performed with other analog input channel, other data transfer channel, for which other data transfer control conditions are set, is used to transfer the converted data to a memory. The direct memory access controller comprises control registers for which a data transfer control conditions are set for each data transfer channel.

In the case of using a data transfer controller instead of a direct memory access controller, data transfer conditions are previously set in a memory, so that when a data transfer request is received, the data transfer control conditions corresponding to the request is loaded from the memory to the control register of the data transfer controller and the data transfer is performed according to the loaded conditions. Unlike a direct memory access controller, a data transfer controller doesn't need to comprise control registers for which a data transfer control conditions are set for each data transfer channel, but it is required to load data for data transfer control from the memory to its register every time a request of data transfer is received.

The single-chip microcomputers are described in “LSI HANDBOOK,” Tokyo: Ohmsha Ltd., Nov. 30, 1984, pp540-541.

### SUMMARY OF THE INVENTION

From a study of the peripheral circuit such as an analog-to-digital converter and data transfer control circuit such as a direct memory access controller, we found as follows.

If a data register is provided for each input channel in peripheral circuits such as an analog-to-digital converter, an increase in a chip area occupied by data registers become considerable with an increasing number of input channels due to the extension of their functionality.

If a different data transfer request is caused in a direct memory access controller every time a peripheral circuit stores data in a data register corresponding to an input channel, the data transfer channels of the direct memory access controller must be at least as many as the input channels. Each data transfer channel of the direct memory access controller has a control register for which transfer control conditions such as a source address, a destination address, and the number of transferred words are set, so that an increase in a chip area occupied by the transfer control registers become considerable with an increasing number of data transfer channels.

If a different data transfer request is caused in a data transfer controller every time a peripheral circuit stores data in a data register corresponding to an input channel, the data transfer controller is required to internally transfer data to be transfer-controlled from the memory to a control register for each transfer request, which inevitably results in the reduction of data processing efficiency.

It is an object of the invention to provide a data processor in which the number of data registers can be reduced with respect to the number of the input channels of a peripheral circuit.

It is another object of the invention to provide a data processor not required to increase the number of data transfer channels even if the input channels of a peripheral circuit are increased.

It is a further object of the invention to provide a data processor in which the internal transfer processing to transfer data to be transfer-controlled from a memory to a transfer control register in response to a data transfer request from a peripheral circuit is reduced.

It is a still further object of the invention to provide a data processor wherein an increase in the number of data registers due to an increasing number of the input channels of peripheral circuits can be suppressed and the overhead resulting from data transfer control can be reduced.

The above and other objects and novel features of the invention will appear from the following description and the accompanying drawings herein.

The typical embodiments of the invention disclosed herein will be described in brief below.

[1] Destination Address Low-order Control by Peripheral Circuit

In the first embodiment of the invention, a peripheral circuit performs the processing of data input from input terminals such as input channels to the peripheral circuit, and the results are transferred to destinations, the low-order bits of which can be controlled by the peripheral circuit.

The data processor comprises a central processing unit, a data transfer control circuit for controlling data transfers under control of the central processing unit, and a peripheral circuit for requesting data transfers. The peripheral circuit selects an input terminal thereof such as an input channel, processes input data from the selected input terminal, requests the transfer of the processing result, and outputs identification information (CH2 to CH0) which permits the identification of the selected input terminal. The data transfer control circuit has a destination address register (DAR) with its low-order bits variable according to the identification information from the peripheral circuit.

Therefore, the peripheral circuit is not required to comprise data registers for storing the processing results of input data according to the number of input terminals. The low-order bits of a destination address register are automatically updated based on the identification information from the peripheral circuit, so that the data transfer channels of data transfer control circuits such as a direct memory access controller are not required to be increased with respect to the number of the input channels of the peripheral circuit. It is not necessary to perform an internal transfer processing of data to be transfer-controlled from a memory to a control register each time the peripheral circuit requests data transfer to a data transfer control circuit such as a data transfer controller.

For example, the peripheral circuit is an analog-to digital converter having a converter section and a converter control section for converting analog signals to digital data. The converter section has analog input channels and a conversion data register shared for storing the results of conversion of input signals from analog input channels. The converter control section requests the transfer of conversion results stored in the conversion data register and outputs code information as an above-described identification information which permits the identification of the analog input channel corresponding to its conversion result.

In more detailed description, the converter section may be arranged to have an analog multiplexer for selecting one of analog input channels and convert analog signals from the analog input channel selected by the analog multiplexer in digital data in a successive approximation procedure.

In this case the converter control section may be arranged to have a channel-select register for holding selection information which allows the multiplexer to select an analog input channel, and output the selection information held in the channel-select register as above-described code information. Additionally, to support a scan mode for analog input channels, the converter control section may be provided with computing element for incrementing the value in the channel-select register to activate the increment operation of the computing element one per scan execution.

The data transfer control circuit is a circuit for controlling data transfers by loading transfer control conditions from a memory in response to data transfer requests, and may be arranged as a data transfer controller wherein address information set in a destination address register can be overwritten with above-described identification information according to the loaded transfer control conditions.

Also above-described data transfer control circuit is a circuit for controlling data transfers according to transfer control conditions previously set by a central processing unit, and may be arranged as a direct memory access controller wherein address information set as transfer control conditions in a destination address register can be overwritten with above-described identification information.

The data processor may have a RAM that can be addressed using address information held by the destination address register. The data processor may be formed in a single semiconductor chip with a RAM.

[2] Destination Address Low-order Control by Peripheral Circuit

In the second embodiment of the invention, a peripheral circuit performs the processing in response to the occurrence of events, and the results are transferred to destinations, the low-order bits of which can be controlled by the peripheral circuit.

The data processor comprises a central processing unit, a data transfer control circuit for controlling data transfers under control of central processing unit, and a peripheral circuit for requesting data transfers. The peripheral circuit performs processing in response to the occurrence of an event to be dealt with, requests the transfer of the processing result, and outputs identification information (EIT1 to EIT0) which permits the identification of the event occurrence corresponding to the processing result. The data transfer control circuit has a destination address register (DAR) with its low-order bits variable according to identification information from the peripheral circuit.

Therefore, the peripheral circuit is not required to comprise data registers for storing the processing results in response to the inputs of events, one for each event input channel. The low-order bits of a destination address register are automatically updated based on the identification information from the peripheral circuit, so that the data transfer channels of data transfer control circuits such as direct memory access controllers are not required to be increased with respect to the number of the input channels of the peripheral circuit. It is not necessary to perform a internal transfer processing of data to be transfer-controlled from a memory to a control register each time the peripheral circuit requests data transfer to a data transfer control circuit such as data transfer controllers.

For example, the peripheral circuit is a free running timer having a counter section and a counter control section, wherein the counter section comprise a counting element and a data register for storing the counted values of the counting element. The counter control section stores the counted values of the counting element in the data register in response to the notice of event occurrence from event input channels to be dealt with, requests the transfers of the counted values stored in the data register, and outputs code information which enables the event input channel with such a change to be discriminated from other event input channels as above-described identification information. In this case, the data register is an input capture register shared by a plurality of event input channels.

Above-described data transfer control circuit is a circuit for controlling data transfers by loading transfer control conditions from a memory in response to data transfer requests, and may be arranged as a data transfer controller wherein address information set in the destination address register can be overwritten with above-described identification information according to the loaded transfer control conditions.

Also above-described data transfer control circuit is a circuit for controlling data transfers according to transfer control conditions previously set by a central processing unit, and may be arranged as a direct memory access controller wherein address information set as transfer control conditions in the destination address register can be overwritten with above-described identification information.

The data processor may have a RAM that can be addressed using address information held by the destination address register. The data processor may be formed in a single semiconductor chip with a RAM.

[3] Source and Destination Address Low-order Control by Peripheral Circuit

In the third embodiment of the invention, a peripheral circuit performs the processing of data input from input terminals such as data input channels, and the results are transferred to sources and destinations, the low-order bits of which can be controlled by the peripheral circuit.

The data processor comprises a central processing unit, a data transfer control circuit for controlling data transfers under control of central processing unit, and a peripheral circuit for requesting data transfers. The peripheral circuit selects a data input channel thereof, performs a predetermined processing for input data from the selected data input channel, requests the transfer of the processing result, and outputs identification information (CH2 to CH0) which permits the identification of the data input channel corresponding to the processing result. The data transfer control circuit has a source address register (SAR) and a destination address register (DAR) with their low-order bits variable according to the identification information from the peripheral circuit.

The peripheral circuit has a plurality of data registers for storing the processing results of input data from the data input channels, the low-order bits of the source address and destination address of such data registers are automatically updated based on the identification information from the peripheral circuit, so that the data transfer channels of data transfer control circuits such as direct memory access controllers are not required to be increased with respect to the number of the input channels of the peripheral circuit. It is not necessary to perform a internal transfer processing of data to be transfer-controlled from a memory to a control register each time the peripheral circuit requests data transfer to a data transfer control circuit such as data transfer controllers. The third embodiment is more effective, for example, in the case that the data input intervals from data input channels are short in comparison with the first embodiment. In other words, it is useful when data registers provided corresponding to individual data input channels are required to act as data buffers.

[4] Source and Destination Address Low-order Control by Peripheral Circuit

In the fourth embodiment, a peripheral circuit performs the processing in response to the occurrence of events, and the results are transferred to sources and destinations, the low-order bits of which can be controlled by the peripheral circuit.

The data processor comprises a central processing unit, a data transfer control circuit for controlling data transfers under control of central processing unit, and a peripheral circuit for requesting data transfers. The peripheral circuit performs processing in response to the notice of event occurrence from event input channels to be dealt with, requests the transfer of the processing result, and outputs identification information (EIT1 to EITO) which permits the identification of the event input channel corresponding to the processing result. The data transfer control circuit has a source address register (SAR) and a destination address register (DAR) with their low-order bits variable according to the identification information from the peripheral circuit.

The peripheral circuit has a plurality of data registers for storing the processing results in response to the notice of the occurrence of events, the low-order bits of the source address and destination address of such data registers are automatically updated based on the identification information from the peripheral circuit, so that the data transfer channels of data transfer control circuits such as direct memory access controllers are not required to be increased with respect to the number of the event input channels of the peripheral circuit. It is not necessary to perform a internal transfer processing of data to be transfer-controlled from a memory to a control register each time the peripheral circuit requests data transfer to a data transfer control circuit such as data transfer controllers. The fourth embodiment is more effective, for example, in the case that event occurrence intervals from event input channels are short in comparison with the second embodiment. In other words, it is useful when data registers provided corresponding to individual event input channels are required to act as data buffers.

### BRIEF DESCRIPTION OF THE DRAWINGS

The invention will be more particularly described with reference to the accompanying drawings, in which:

FIG. 1 is a block diagram of an embodiment of a data processor of the invention;

FIG. 2 is a block diagram showing a detail of an ADC of the invention;

FIG. 3 is a block diagram showing an example of an FRT in detail;

FIG. 4 is a block diagram showing an example of a DTC in detail;

FIG. 5 is a block diagram diagrammatically showing operations with respect to a destination address when A/D conversion results of the ADC are transferred to a RAM;

FIG. 6 is an explanation drawing illustrating address bits A1, A2, and A3 which will be operated according to channel select bit string information CH2 to CH0;

FIG. 7 is an address map showing the situation where the A/D conversion results with respect to analog input signals from the analog input terminals AN0 to AN7 is transferred from the data register ADDR to the RAM 5;

FIG. 8 a block diagram showing a configuration example for comparison provided by adopting the ADC having a plurality of A/D conversion data registers ADDR0 to ADDR7 corresponding to analog input terminals AN0 to AN7;

FIG. 9 is a flow chart illustrating the AID conversion operation from the analog input terminals AN0 to AN7 in the ADC according to the scan mode;

FIG. 10 an explanation drawing showing the sates of the channel select bit string information CH2 to CH0 successively updated according to the procedure of processing shown in FIG. 9 and the address bits A3, A2, and A1 of the register DAR changed in response to the update corresponding to the A/D conversion processes with respect to the inputs of analog input terminals AN0 to AN7;

FIG. 11 an explanation drawing showing the state that data is transferred form the data register ADDR of the ADC to the predetermined areas of the RAM according to the procedure of processing shown in FIG. 9 corresponding to the A/D conversion results with respect to the inputs from the analog input terminals AN0 to AN7;

FIG. 12 is a block diagram diagrammatically showing the operation with respect to destination addresses when the data loaded into the input capture register ICR in the FRT by the input capture action is transferred to the RAM;

FIG. 13 is an explanation drawing illustrating the timing of input captures and the sates of the counted values of the timer counter TCNT at the time of input capture occurrence;

FIG. 14 is an address map showing the situation where the count data is transferred to different addresses on the RAM by operating the low-order two bits of the destination address register based on event input terminal identification information;

FIG. 15 is a block diagram showing a configuration example for comparison provided by adopting a FRT having a plurality of input capture registers corresponding to event input terminals;

FIG. 16 is a block diagram illustrating the configuration of a data processor 1A with a DMAC instead of the DTC;

FIG. 17 is a flow chart illustrating the A/D conversion operation in the ADC according to the scan mode when the DMAC shown in FIG. 16 is used;

FIG. 18 is a block diagram a data processor so arranged that both source and destination addresses are controlled with analog input terminal select bit string information;

FIG. 19 is an explanation drawing illustrating address bits A1, A2, and A3 in both of a source and a destination, which will be operated based on analog input terminal select bit string information;

FIG. 20 is an address map illustrating the situation where data is transferred according to the configuration of FIG. 18; and

FIG. 21 is a block diagram illustrating a data processor so arranged that both source and destination addresses are controlled with event input channel identification information.

### DESCRIPTION OF THE PREFERRED EMBODIMENTS

### Data Processor

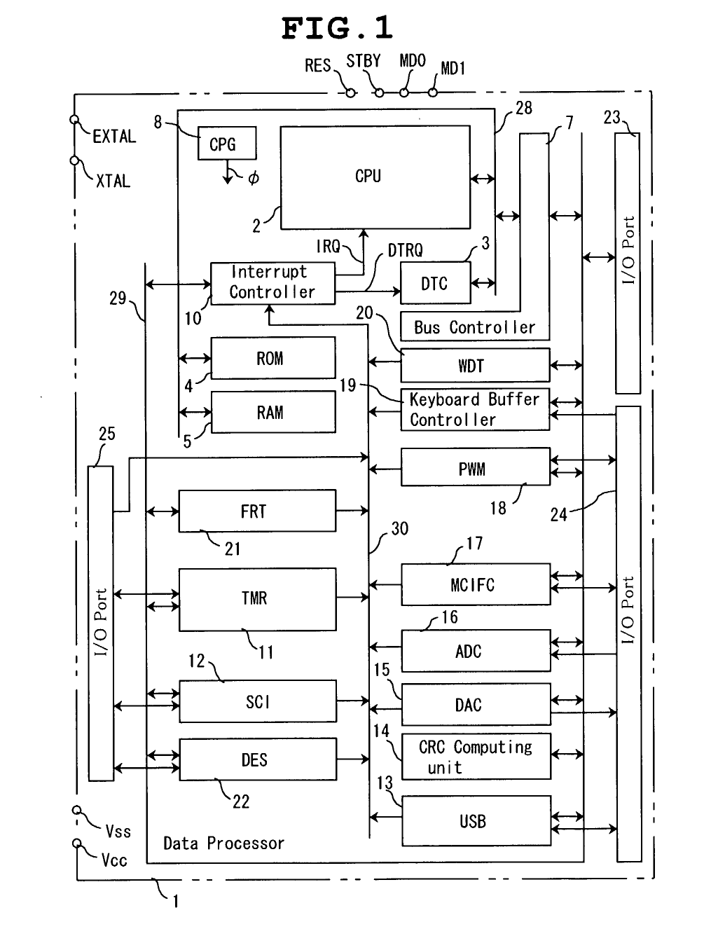

FIG. 1 shows an example of a data processor 1 according to the invention. For example, the data processor 1 illustrated therein may be formed on a single semiconductor substrate (semiconductor chip) such as a bulk of single crystal silicon using CMOS IC fabrication techniques.

Data processor 1 has a central processing unit (CPU) 2, a data transfer controller (DTC) 3, a read-only memory (ROM) 4 which is a program memory for storing programs including processing programs for the CPU 2, a random access memory (RAM) 5 used as a work area for the CPU 2 and for the temporary storage of data, a bus controller 7, a clock pulse generator circuit (CPG) 8, an interrupt controller 10, a timer counter (TMR) 11, a serial communication interface controller (SCI) 12, a universal serial bus controller (USB) 13, a CRC computing unit 14, a digital-to-analog converter (DAC) 15, an analog-to-digital converter (ADC) 16, a memory card interface controller (MCIFC) 17, a pulse width modulator (PWM) 18, a keyboard buffer controller 19, a watchdog timer (WDT) 20, a free running timer (FRT) 21, a data encryption standard computing unit (DES) 22, and I/O ports 23 to 25. The CPU 2, DTC 3, ROM 4, RAM 5, and bus controller 7 are connected to a CPU bus 28. The CPU bus 28 is interfaced with a peripheral bus 29 through the bus controller 7, the peripheral bus 29 is connected to peripheral circuits such as the interrupt controller 10, TMR 11, SCI 12, USB 13, CRC computing unit 14, DAC 15, ADC 16, MCIFC 17, PWM 18, keyboard buffer controller 19, WDT 20, and data encryption standard computing unit 22. The CPU bus 28 and peripheral bus 29 each include a data bus, an address bus, and a control signal bus. The peripheral bus 29 is interfaced with an external bus (not shown) through the I/O port 23, and the CPU bus 28 is interfaced with the peripheral bus 29 through the bus controller 7, and then interfaced with the external bus through the I/O port 23. The I/O ports 24 and 25 may act as external interface buffers for peripheral circuits. For example, an analog input terminal for a predetermined analog input channel of the ADC 16 is allocated to a given port of the I/O port 24.

The CPU 2 and DTC 3 are bus master modules in the data processor 1. The CPU 2 has an instruction control section, for example, which fetches instructions from the ROM 4 and interprets the fetched instructions, and an execution section which performs computations using a device such as a general register and an arithmetic logical computing unit according to the interpretation results of instructions. The data transfer control conditions of the DTC 3 are preset in the RAM 5 by the CPU 2, when the ADC 16 or FRT 21 causes a data transfer request, the corresponding data transfer control conditions are load from the RAM 5 into the DTC 3, and then the DTC 3 performs data transfer control according to the loaded transfer control conditions.

The bus controller 7 arbitrates the contention of requests for the right to use a bus among two bus master modules, namely CPU 2 and DTC 3, and an external bus master. The arbitration logic is, for example, arbitration control based on priorities. As a result of the arbitration, a bus master module provided with the right to use a bus outputs a bus command, and then the bus controller 7 controls the bus based on this command. If address signals output by a bus master module represent the external address space of the data processor 1, the bus controller 7 outputs address signals and access strobe signals to the outside through the I/O port 23.

The interrupt controller 10 receives internal interrupt signals output from peripheral circuits such as FRT 21 and ADC 16 connected to the peripheral bus 29, and external interrupt signals input from the outside through the I/O port 25. The internal interrupt signals and external interrupt signals are collectively indicated by a reference numeral 30. The interrupt controller 10 performs the control based on priorities and mask with respect to input interrupt signals and honors an interrupt request. When the interrupt controller 10 accepts a interrupt request, it outputs an interrupt request signal IRQ to the CPU 2 depending on the type of the interrupt request signal or outputs a DTC activation request signal DTRQ to the DTC 3.

When the CPU 2 receives an interrupt request signal IRQ, the CPU 2 suspends its current process execution to branch to a predetermined service routine depending on the interruption factor. At the end of the service routine to which the CPU 2 branches a return instruction is executed, whereby the suspended process can be resumed.

The interrupt controller 10 is provided with data transfer control enable registers (DTCER), one for each DTC channel, and arranged so as to set whether the DTC activation is enabled or disabled with respect to plural types of interruption factors. If it set to enable, the occurrence of corresponding interruption factor activates a DTC activation request signal DTRQ of the corresponding DTC channel. If it set to disable, the occurrence of corresponding interruption factor activates an interrupt request signal IRQ. The interruption factors which enable the activation of the DTC 3 include an input capture interrupt and a compare match in the FRT 21, a conversion ending interrupt in the ADC 16, and a completion-of-sending interrupt and a completion-of-reception interrupt in the SCI 12, but are not particularly limited so. A DTC vector number and corresponding vector address are determined for each interruption factor which enables the activation of the DTC 3. The vector address contains the head address of an area on the RAM, in which data transfer control conditions activated by a corresponding DTC activation request are stored. When a DTC activation request signal DTRQ is supplied to the DTC 3 from the interrupt controller 10, the corresponding DTC vector is also supplied to the DTC 3. The DTC 3 loads a transfer control register with the data transfer control conditions on the RAM 5 that the DCT vector indicates and performs a data transfer control according to the loaded transfer control conditions and other conditions.

The details will be described later, when the AD conversion results with respect to data input from analog input channels are obtained in the ADC 16, the low-order bits of destination address to which the AD conversion results are transferred using the DTC 3 can be controlled by the ADC 16. Also, when input capture processing is performed in response to the occurrence of events to obtain a count value in the FRT 12, the low-order bits of destinations to which the count value is transferred using the DTC 3 can be controlled by the FRT 21.

In addition, the data processor 1 has external terminals such as ground level (Vss) and source voltage level (Vcc) as power supply terminals, and other terminals of reset input (RES), standby (input STBY), mode control input (MD0, MD1), and clock input (EXTAL, XTAL) as specialized control terminals.

The CPG 8 generates system clock signals ø using a crystal resonator connected to terminals EXTAL and XTAL, or external clock signals input to the EXTAL terminal, the system clock generating method is not particularly so limited.

When the data processor 1 receives a reset signal RES, the on-chip circuit modules such as the CPU 2 become reset. When this reset state resulting from the receipt of a reset signal RES is released, the CPU 2 loads an instruction from a predetermined start address, starts the execution of a program, follows the program, for example, fetches data from the RAM 5, performs the computation processing of the fetched data, performs the input/output of signals with respect to the outside based on the processing results using devices such as a FRT 21 and ADC 16, and controls various equipment.

### ADC

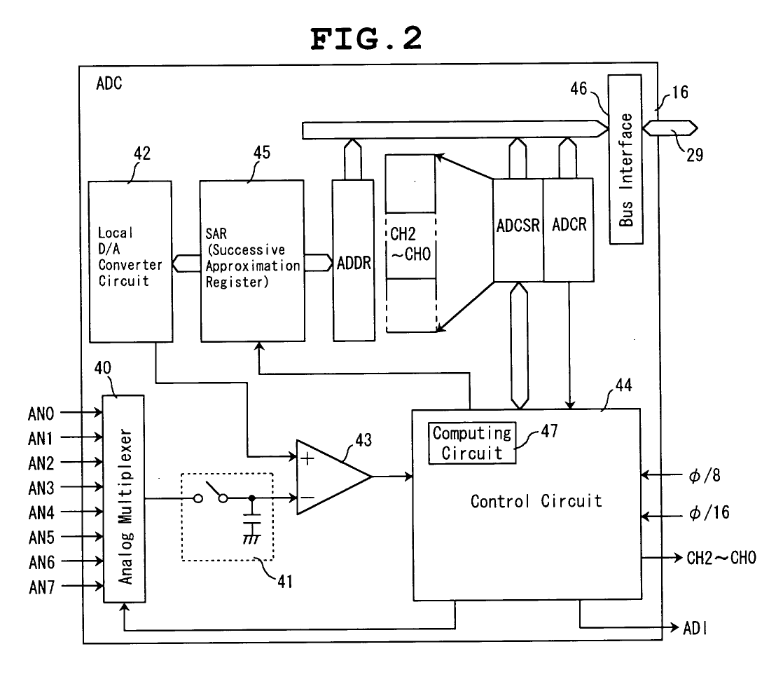

FIG. 2 shows an example of the ADC 16 in detail. The ADC 16 selects one of analog signals supplied from analog input terminals AN0 to AN7 using an analog multiplexer 40 and samples the selected analog signal with a sample hold circuit 41. The sampled analog voltage signal is compared to the output voltage of a local D/A converter circuit 42 by a comparator 43. The control circuit 44 receives the comparison results, and controls the values of a successive approximation register 45 according to the comparison results. The local D/A converter circuit 42 converts the values of the successive approximation register 45 to analog form to produce analog voltage signals to be output to the comparator 43. If a value obtained in the successive approximation register 45 converges due to this successive approximation operation, the value is set in an AD conversion data register ADDR as digital data corresponding to an input analog signal. When the digital data is set in the AD conversion register ADDR, the control circuit 44 asserts an AD conversion ending interrupt signal ADI to the interrupt controller 10. The control section of the ADC 16 consists of a control circuit 44, a status control register ADCSR, and a control register ADCR. The AD conversion data register ADDR, status control register ADCSR, and control register ADCR are connected to a peripheral bus 29 through a bus interface 46.

The control register ADCR includes A/D conversion start/stop control bits, and a clock select bit for setting a clock which determines an A/D conversion time.

The status control register ADCSR includes a selection field for analog input channels or analog input terminals and a conversion mode designation field. However, analog input channels are herein regarded as the equivalents of analog input terminals.

The conversion mode designation field sets the operation mode of the ADC 16 at a single mode, four-channels scan mode, or eight-channels scan mode depending on its setting value. The single mode is an operation mode in which an AD conversion is performed one time with respect to an analog input terminal selected in the selection field of analog input terminals and the operation is completed. The scan mode is an operation mode in which AD conversion with respect to a plurality of channels are successively performed. The four-channels scan mode is an, operation mode in which AD conversions with respect to the four channels of AN0 to AN3 or AN4 to AN7 selected in the selection field of analog input terminals, are successively performed. The eight-channels scan mode is an operation mode in which input signals from the eight terminals of AN0 to AN7 are converted from analog form to digital equivalents successively.

The selection field of analog input terminals is a information field which allows a multiplexer to select an input terminal according to its value. For example, the selection field of an analog input terminal is particularly limited, but consists of 3-bits channel select bit string of CH2, CH1, and CH0. In this case, there is a relationship such that the analog input terminal number (channel number) increases by one each time the value of (CH2, CH1, CH0) is incremented by one, i.e. when (CH2, CH1, CH0)=(0, 0, 0), (CH2, CH1, CH0)=(0, 0, 1), (CH2, CH1, CH0)=(0, 1, 0), and (CH2, CH1, CH0)=(0, 1, 1), the AN0, AN1, AN2, and AN3 are selected respectively.

The values of the registers ADCSR and ADCR is initialized by the CPU 2. In the scan modes, the values of the analog input terminal select bit strings CH2 to CH0 of the register ADCSR are incremented by the computing circuit 47 incorporated in the control circuit 44 according to the operation mode for each A/D conversion action.

The control circuit 44 supplies the DTC 3 with the values of the analog input terminal select bit string CH2 to CH0 of the status control register ADCSR (also hereinafter simply referred to as channel select bit string information CH2 to CH0).

For example, in the case of single mode, when the results of A/D conversion are set in the data register ADDR, channel select bit string information CH2 to CH0, which represents analog input channel numbers set by the CPU 2 as is subjected to the A/D conversion operation, is output. In scan modes, at the start, channel select bit string information CH2 to CH0 which represents analog input channel numbers set by the CPU 2 as the subjects of the A/D conversion operation is output, and then the channel select bit string information CH2 to CH0 incremented by the sequential computing circuit 47 is successively output. To sum up, a single data register ADDR is provided regardless of the number of the input channels, whereas the input channel (analog input terminal number) information of data corresponding to the A/D conversion results stored in the data register ADDR is output as the information of channel select bit string CH2 to CH0 to the DTC 3, whereby enabling the identification of data on input channels(analog input terminals) corresponding to data of the A/D conversion results.

The control circuit 44 also supplies interrupt controller 10 with the channel select bit string information CH2 to CH0, whereby the judgement of interruption factor of an AD conversion ending interrupt signal ADI is performed. In other words, the difference among data input channels (analog input terminal numbers) corresponding to A/D conversion results stored in the data register ADDR is regarded as the difference among their interruption factors, so that different interruption factors results in different vectors for the DTC 3.

### FRT

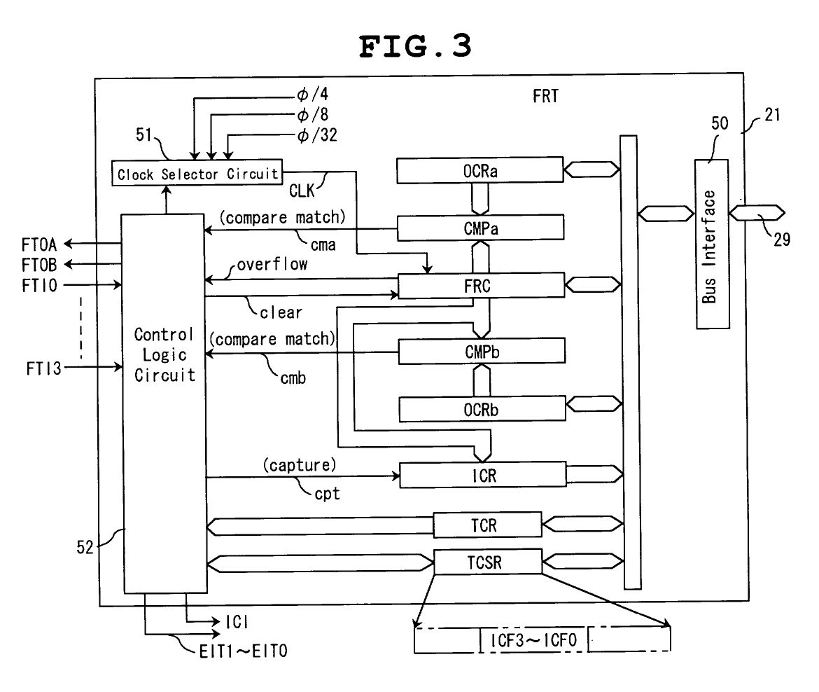

FIG. 3 shows an example of the FRT 21 in detail. The FRT 21 has a counter section comprising a free running counter FRC, output compare registers OCRa and OCRb, comparator circuits CMPa and CPMb, and an input capture register ICR. The output compare registers OCRa and OCRb, and the input capture register ICR are connected to the peripheral bus 29 through the bus interface 50. The free running counter FRC keeps count of clock signals CLK selected by the clock selector circuit 51. The comparator circuits CMPa and CMPb detect the agreement between the counted value of the free running counter FRC and the setting values of the output compare registers OCRa, OCRb to output compare-match signals cma and cmb. The input capture register ICR latches the counted value of the free running counter FRC when capture signals cpts are asserted.

The FRT 21 has a counter control section comprising a control logic circuit 52, a clock selector circuit 51, a timer control status register TCSR, and a timer control register TCR. The control logic circuit 52 has output-compare signal output terminals FTOA and FTOB for outputting the matching detection by compare-match signals cma and cmb as an event output to the outside. The control logic circuit 52 activates a capture signal cpt to cause the input capture register ICR to latch the counted values of the free running counter FRC when the occurrence of events is noticed from input-capture signal input terminals FTI3 to FTI0 which are event input terminals.

The timer control register TCR holds information such as control information for determining which of the rising or falling edge of input signals from input-capture signal input terminals FTI3 to FTI0 is used to detect an event occurrence for input capture action, and clock signal selection information of the clock selector circuit 51. The timer control status register TCSR has four bits of input capture flags ICF3 to ICF0, and two bits of output compare flags (not shown). The two bits of output compare flags show the results of the matching detection reflected on the compare-match signals cma and cmb. The input capture flags ICF3 to ICF0 are flags for identifying input-capture signal input terminals FTI3 to FTI0 used to notice of the occurrence of the events regarded as the factors of input capture action. The input capture flag corresponding to the input-capture signal input terminal used for notice of the event occurrence is set at “1”.

If any of the input capture flags ICF3 to ICF0 are set at “1”, the control logic circuit 52 asserts an input capture interrupt signal ICI to the interrupt controller 10. Then, the control logic circuit 52 also encodes the input capture flags ICF3 to ICF0 to output two bits of event input terminal (event input channel) identification information EIT1 and EIT0. As for these event input terminal identification information EIT1 and EIT0, for example, FTI0, FTI1, FTI2, and FTI3 correspond to (EIT1,EIT0)=(0, 0), (EITl,EIT0)=(0, 1), (EIT1,EIT0)=(1, 0), and (EIT1,EIT0)=(1, 1) respectively. These event input terminal identification information EIT1 and EIT0 are output to the DTC 3 and interrupt controller 10. In the interrupt controller 10, the units of event input terminal identification information EIT1 and EIT0 are utilized as the interruption factors of input capture interrupt signals ICIs. Regardless of plurality of input-capture signal input terminals FTI3 to FTI0, a single input capture register ICR is provided, whereas information that which event (or terminal for the notice of event occurrence) may be the factor of input capture action with respect to the register ICR is provided to DTC 3 by event input terminal identification information EIT1 and EIT0, whereby it becomes possible to identify which event occurrence is in correlation with latch data in the input capture register ICR.

### DTC

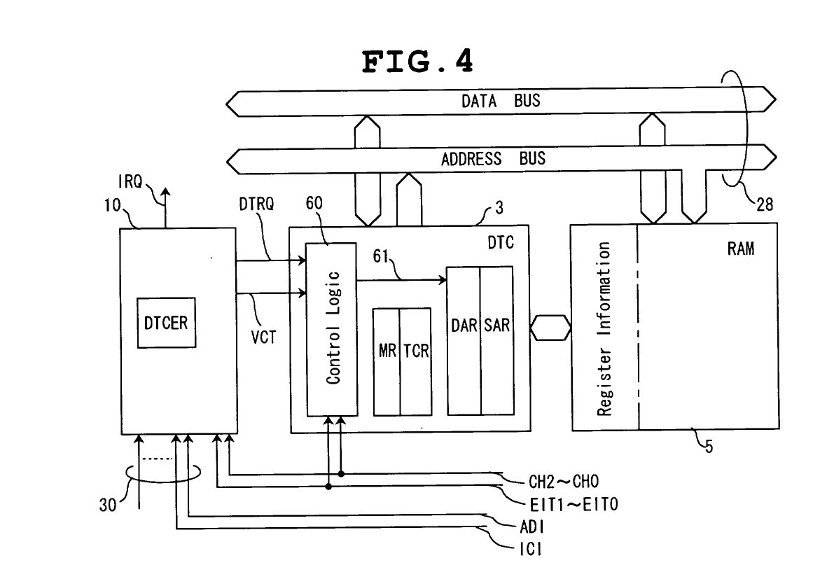

FIG. 4 shows an example of the DTC 3 in detail. The DTC 3 has a control logic 60, a mode register MR, a transfer count register TCR, a destination address register DAR, and a source address register SAR. The source address register SAR holds a source address and the destination address register DAR holds a destination address. In the mode register MR, information of whether or not incrementing or decrementing actions were performed with respect to the destination address register DAR and source address register SAR after transmission, a transferred data size, and a transfer mode are set. Data on the number of times of transfers is preset in the transfer count register TCR, which is utilized for control, for example, such that the preset count is decremented each time data is transferred and the transfer action is completed when the value of the counter returns to the initial value.

The interrupt controller 10 provides the control logic 60 with DTC activation request signals DTRQs and vectors VCTs depending on their activation factors. The interrupt controller 10 is provided with data transfer control enable registers DTCERS, one for each of interruption factors of ADC conversion ending interrupt signals ADIs and input capture interrupt signals ICIs. The judgement of the activation factor and interruption factor by the interrupt controller 10 is performed based on channel select bit string information CH2 to CH0 or event input channel identification information EIT1 and EIT0 when interruption is requested with an interrupt signal ADI or ICI.

The control logic 60 is supplied with channel select bit string information CH2 to CH0 from the ADC 16 and the event input channel identification information EIT1 and EIT0 from the FRT 21. As for which of channel select bit string information CH2 to CH0 or event input channel identification information EIT1 and EIT0 is effective information, the judgement may be performed with a vector VCT provided by interrupt controller 10.

When the interrupt controller 10 activates a DTC activation request signal DTRQ and the corresponding vector VCT is supplied, the control logic 60 loads the register information (data transfer control conditions) on the RAM 5 indicated by the vector VCT into transfer control registers MR, TCR, DAR, and SAR and data transfer control starts according to the loaded transfer control conditions.

If this data transfer is the response to an ADC conversion ending interrupt signal ADI from the ADC 16, the low-order three bits of the destination address register DAR are determined by low-order address information 61 corresponding to channel select bit string information CH2 to CH0. Therefore, when A/D conversion results are transferred from the data register ADDR of the addresses indicated by the address register SAR to the addresses on the RAM indicated by the address register DAR, the A/D conversion results in different A/D conversion channels are held in the same data register temporarily, but those results are separately stored in different areas on the RAM 5 according to the difference of channel select bit string information CH2 to CH0, which protects previous A/D conversion results from being overwritten and erased with new ones undesirably.

IF the data transfer is the response to an input capture interrupt signal ICI from the FRT 21, the low-order two bits of the destination address register DAR are determined by low-order address information 61 corresponding to event input channel identification information EIT1 and EIT0. Therefore, when input capture values (counted values) are transferred from the data register ICR of the addresses indicated by the address register SAR to the addresses on the RAM indicated by the address register DAR, the counted values in response to the occurrence of different events are held in the same data register ICR temporarily, but counted values are separately stored in different areas on the RAM 5 depending on the difference of event input channel identification information EIT1 and EIT0, which protects the capture counted values in response to the inputs of previous events from being overwritten and erased with new ones undesirably.

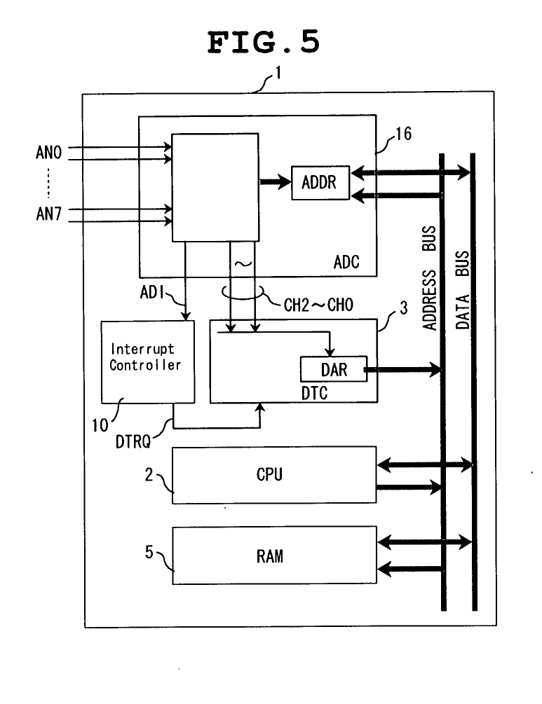

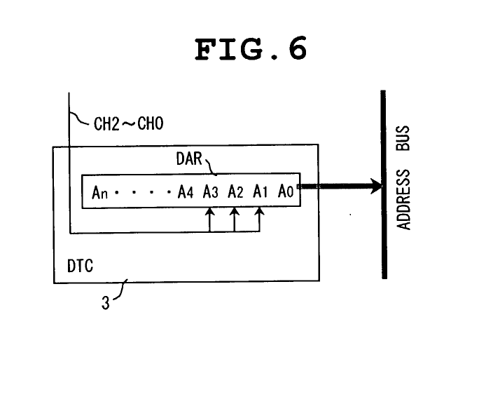

FIG. 5 diagrammatically shows the operation with respect to destination addresses when the A/D conversion results of the ADC 16 are transferred to the RAM 5. AS is clear from FIG. 5, the low-order three bits of the destination address register DAR are determined based on channel select bit string information CH2 to CH0, where the low-order three bits are different in address bit location according to data sizes. For example, if a data size is two bytes for a byte address, three bits of A1, A2, and A3 will be operated based on channel select bit string information CH2 to CH0, as shown in FIG. 6. In the embodiment shown in FIG. 5 buses and circuit blocks are partly omitted, for example, the “data bus” is the general term applied to the data buses of the buses 28 and 29 and the “address bus” is the general term applied to the address busses of the bus 28 and 29.

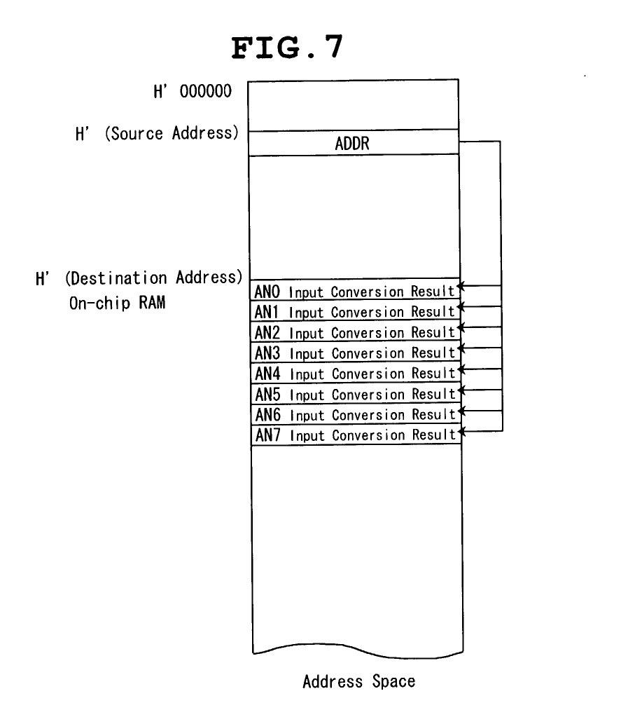

The low-order three bits of the destination address register DAR are operated based on the channel select bit string information CH2 to CH0, so that the A/D conversion results with respect to the analog input signals from the analog input terminals AN0 to AN7 are temporarily held in the same data register ADDR and then stored in different addresses on the RAM 5, as illustrated in FIG. 7.

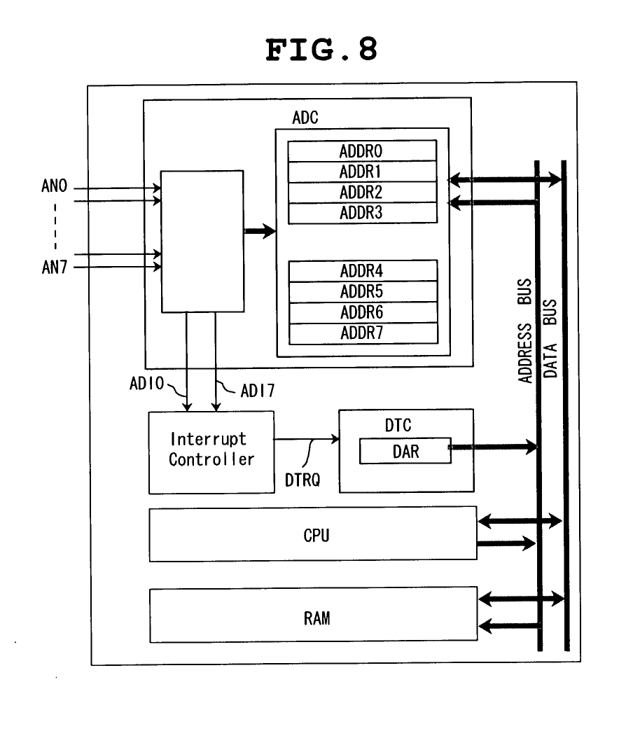

FIG. 8 shows a configuration example for comparison provided by adopting an ADC having a plurality of A/D conversion data registers ADDR0 to ADDR7 corresponding to analog input terminals AN0 to AN7. In the configuration of FIG. 8 eight AD conversion data registers are required, while in FIG. 5 only one is needed. In the configuration of FIG. 8, the A/D conversion ending interrupt signals ADI0 to ADI7 asserted differ from one AD conversion channel to another, so that the data transfer conditions must be transferred from the RAM to the control register of the DTC every time so asserted, which results in overhead. With the configuration of FIG. 5, this overhead is not produced.

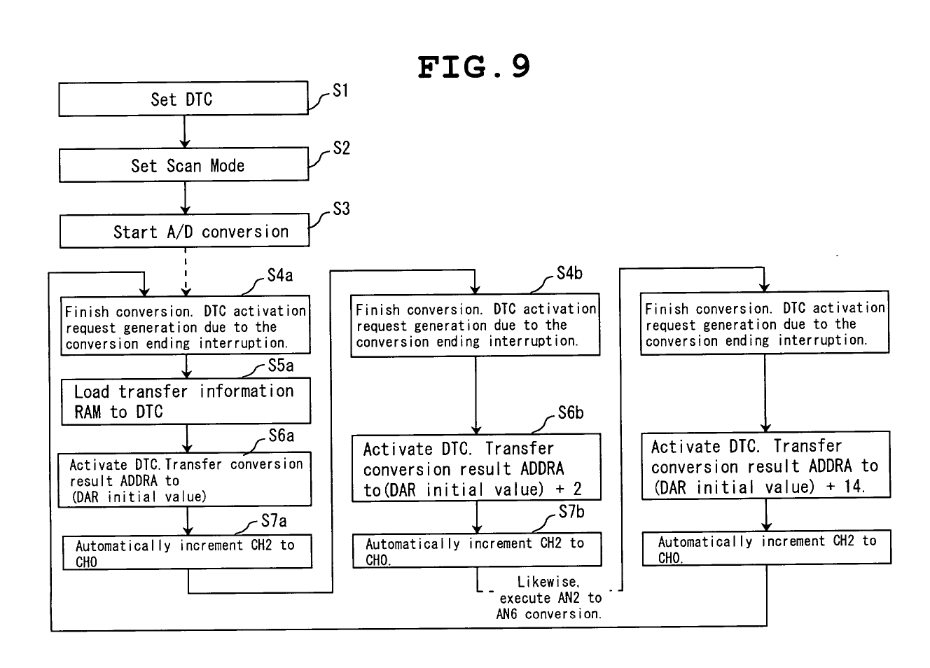

FIG. 9 illustrates a flow chart of A/D conversion operation from analog input terminals AN0 to AN7 in the ADC 16 according to the scan mode.

First, the DTCER is set such that DTC activation request signals are activated in response to AD conversion ending interruptions, transfer control conditions are prestored in the predetermined areas of the RAM to set the DTC (S1). For example, the source address set as a transfer control condition is H'FFE0, and the destination address is H'EC80. Second, the scan mode is set in the control register ADCR of the ADC 16 (S2), A/D conversion operation is started with respect to an analog input from the analog input terminal AN0 (S3). After the A/D conversion is completed, conversion ending interruption is generated, and then the interrupt controller activates DTC activation requests in response to the interruption generation (S4a). In response to this operation, the DTC 3 loads transfer control information from the predetermined area of the RAM 5(S5a), and transfers the conversion result data of the data register ADDR indicated by the source address register SAR to the address on the RAM indicated by the destination address register DAR based on the loaded transfer control information (S6a). At this time, the address bits A3 to A1 of the destination address register DAR are determined with the values of channel select bit string information CH2 to CH0 provided by the ADC 16. Then, the ADC 16 increments the values of channel select bit string information CH2 to CH0 on the control status register ADSCR by one using the computing circuit 47, and starts the A/D conversion operation with respect to an analog input from the next analog input terminal ANI (S7a). After the A/D conversion is completed, a conversion ending interrupt signal ADI is generated, and then the interrupt controller activates a DTC activation request signal DTRQ in response to the interrupt signal (S4b). In response to this operation, the DTC 3, wherein the scan mode has been set already, loads no transfer control information from the predetermined area of the RAM 5, and transfers the conversion result data of the data register ADDR indicated by the source address register SAR to the address on the RAM 5 indicated by the destination address register DAR (S6b). At this time, the values of channel select bit string information CH2 to CH0 from the ADC 16, which determine the address bits A3 to A1 of the destination address register DAR, have been incremented at the step S7a already, and the incremented destination address of the initial values plus two are used for data transfer (S6b). Then, the ADC 16 further increments the values of channel select bit string information CH2 to CH0 on the control status register ADSCR by one using the computing circuit 47, and starts the A/D conversion operation with respect to an analog input from the next analog input terminal AN2 (S7b). Thereafter, the A/D conversion according to the scan mode is continued by repeating a series of similar steps to S4b, S6b, and S7b until the data transfer by the A/D conversion operation with respect to an analog input from the analog input terminal AN7 is executed.

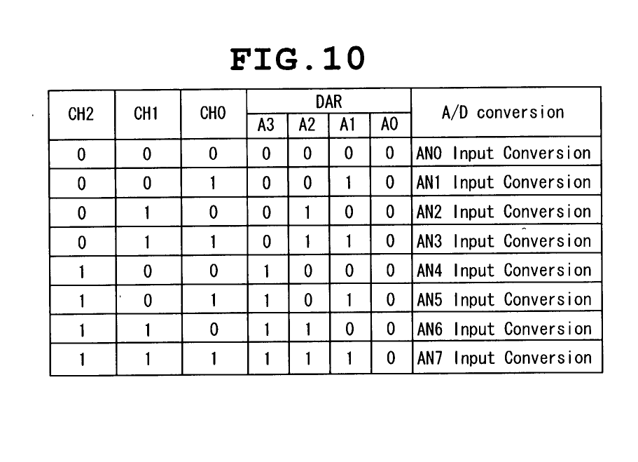

FIG. 10 shows the sates of the sequential channel select bit string information CH2 to CH0 updated according to the procedure of processing shown in FIG. 9 and the address bits A3, A2, and A1 of the register DAR changed in response to the update corresponding to the A/D conversion processes with respect to the inputs of analog input terminals AN0 to AN7.

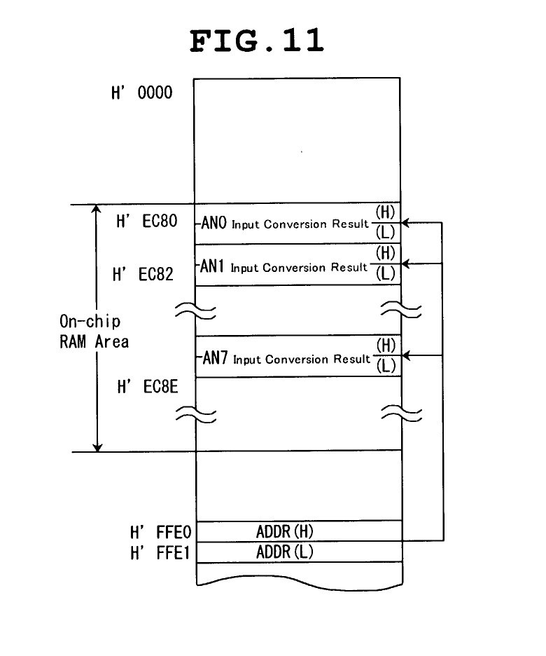

FIG. 11 shows the state that data is transferred form the data register ADDR of the ADC 16 to the predetermined areas of the RAM 5 according to the procedure of processing shown in FIG. 9 corresponding to the A/D conversion results with respect to the inputs from the analog input terminals AN0 to AN7. In this figure, the unit of the address space is a byte address, and it is clearly shown that the data is two bytes of data.

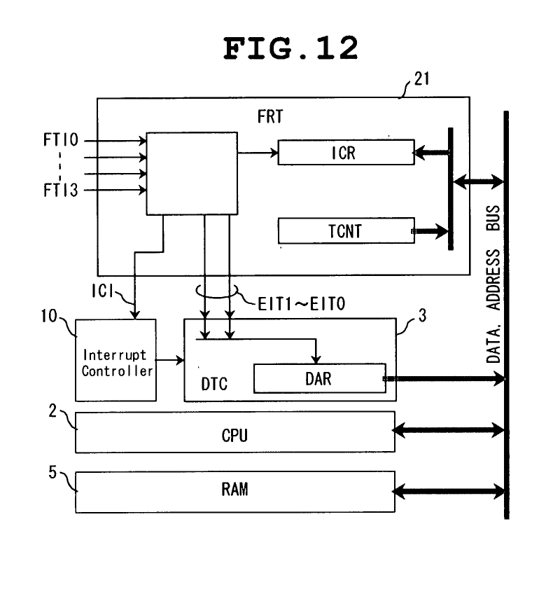

FIG. 12 diagrammatically shows the operation with respect to destination addresses when the data loaded into the input capture register ICR in the FRT 21 by the input capture action is transferred to the RAM 5. As is clear from FIG. 12, the low-order two bits of the destination address register DAR are determined based on event input terminal identification information EIT1 to EIT0, where the low-order two bits are different in address bit location according to data sizes. For example, if a data size is two bytes for a byte address, two bits of A1 and A2 among A0, A1, A2, A3, . . . An will be operated based on event input terminal identification information EIT1 to EIT0. In the embodiment shown in FIG. 12, buses and circuit blocks are partly omitted, for example, the “data address bus” is the general term applied to the buses of 28 and 29.

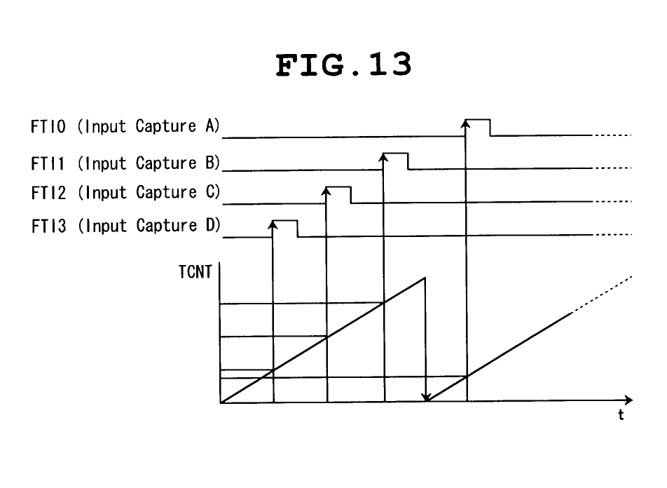

In FIG. 12, when the occurrence of events is noticed from the event input terminals FTI0 to FTI3 in successive time sequence, the counted value of the timer counter TCNT is latched by the input capture register ICR in response to the event occurrence notice. FIG. 13 illustrates the timing of input captures and the sates of the counted values of the timer counter TCNT at the time of input capture occurrence.

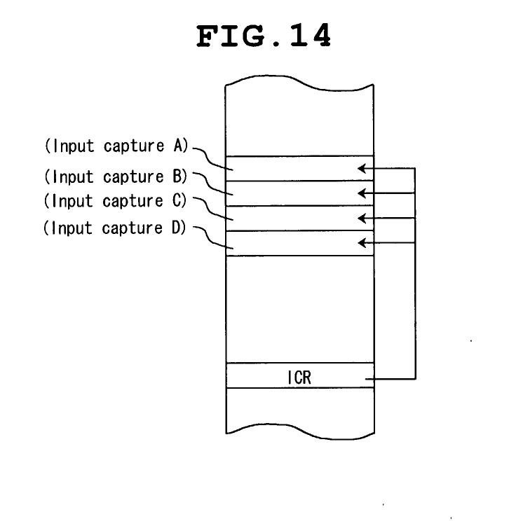

The low-order two bits of the destination address register DAR are operated based on the event input terminal identification information EIT1 to EIT0, so that the counted values of the timer counter TCNT in response to the notices of event occurrence from the event input terminals FTI0 to FTI3 are temporarily held in the same data register ICR and then stored in different addresses on the RAM 5, as illustrated in FIG. 14.

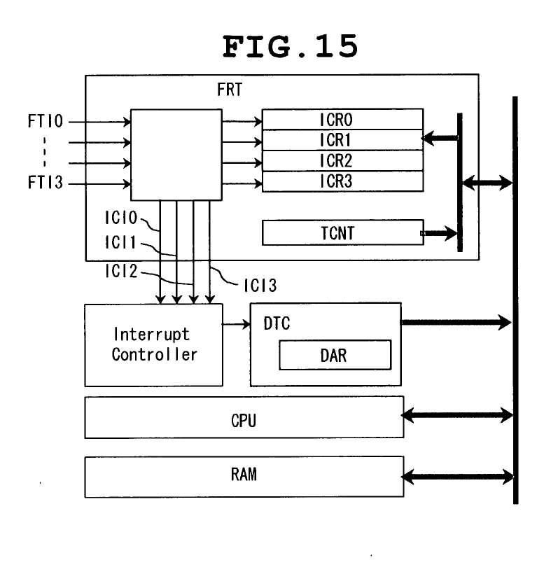

FIG. 15 shows a configuration example for comparison provided by adopting a FRT having a plurality of input capture registers ICR0 to ICR3 corresponding to event input terminals FTI0 to FTI3. In the configuration of FIG. 15 four input capture registers are required, while in FIG. 12 only one is needed. In the configuration of FIG. 15, the input capture interrupt signals ICI0 to ICI3 asserted differ from one event input channel to another, so that the data transfer conditions must be transferred from the RAM to the control register of the DTC every time so asserted, which results in overhead. With the configuration of FIG. 12, this overhead is not produced.

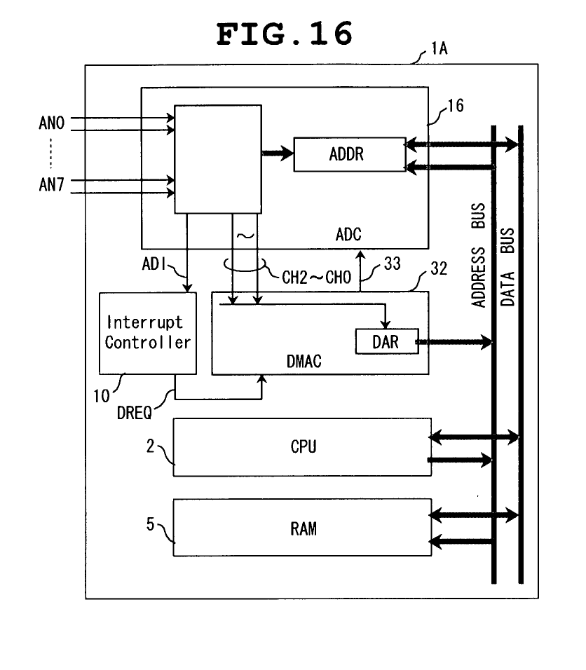

FIG. 16 illustrates the configuration of a data processor 1A with a DMAC (direct memory access controller) 32 instead of the DTC 3. Unlike the DTC 3, the DMAC 32 has a control register wherein data transfer control conditions are preset by the CPU 2, so that the transfer control conditions doesn't have to be loaded from the RAM 5 at each transfer step. The interrupt controller 10 supplies the DMAC 32 with DMA request signal DREQ in response to an A/D conversion ending interrupt signal ADI. Consequently, the DMAC 32 obtains the right to use a bus, and performs a transfer control to transfer the conversion result data in an A/D conversion data register ADDR to the memory address indicated by the destination address register DAR of the DMAC 32. In the DMAC 32, the low-order three bits of the destination address register DAR is determined based on channel select bit string information CH2 to CH0 as in the DTC 3. The low-order three bits of the destination address register DAR are operated based on the channel select bit string information CH2 to CH0, so that the A/D conversion results with respect to the analog input signals from the analog input terminals AN0 to AN7 are temporarily held in the same data register ADDR and then stored in different addresses on the RAM 5. In the configuration of FIG. 16, when a bus cycle is started, the DMAC 32 provides the ADC 16 with a bus cycle signal 33, so that this signal may be used to produce the timing of data output from the register ADDR.

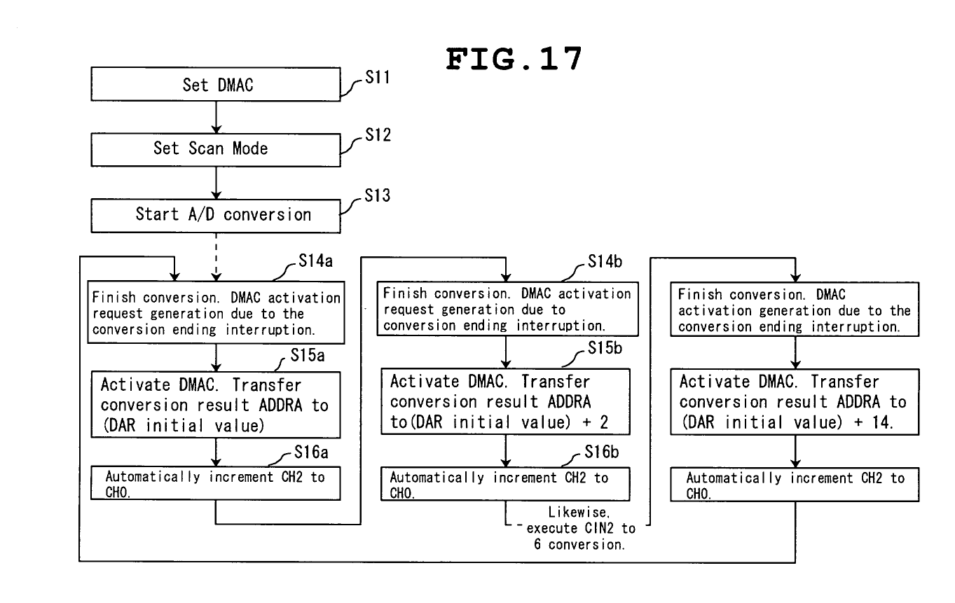

FIG. 17 illustrates a flow chart of A/D conversion operation in the ADC 16 according to the scan mode with respect to analog input terminals AN0 to AN7 when the DMAC 32 shown in FIG. 16 is used.

First, the DTCER is set such that DMA transfer request signals DREQ are activated in response to AD conversion ending interruptions, DMAC 32 is initialized (S11). For example, the source address set as transfer control condition is H'FFE0, and the destination address is H'EC80. Second, the scan mode is set in the control register ADCR of the ADC 16 (S12), A/D conversion operation is started with respect to an analog input from the analog input terminal AN0 (S13). After the A/D conversion is completed, conversion ending interruption is generated, and then the interrupt controller activates DMA transfer request signals DREQ in response to the interruption generation (S14a). In response to this operation, the DMAC 32 transfers the conversion result data of the data register ADDR indicated by the source address register SAR to the address on the RAM 5 indicated by the destination address register DAR based on the initialized transfer control information (S15a). At this time, the address bits A3 to A1 of the destination address register DAR are determined with the values of channel select bit string information CH2 to CH0 provided by the ADC 16. Then, the ADC 16 increments the values of channel select bit string information CH2 to CH0 on the control status register ADSCR by one using the computing circuit 47, and starts the A/D conversion operation with respect to an analog input from the next analog input terminal AN1 (S16a). After the A/D conversion is completed, a conversion ending interrupt signal is generated, and then the interrupt controller activates a DMA transfer request signal DREQ in response to the interrupt signal (S14b). The DMAC 32, wherein the scan mode has been set already, transfers the conversion result data of the data register ADDR indicated by the source address register SAR to the address on the RAM 5 indicated by the destination address register DAR (S15b). At this time, the values of channel select bit string information CH2 to CH0 from the ADC 16, which determine the address bits A3 to A1 of the destination address register DAR, have been incremented at the step S7a already, and the incremented destination address of the initial values plus 2 are used for data transfer. Then, the ADC 16 further increments the values of channel select bit string information CH2 to CH0 on the control status register ADSCR by one using the computing circuit 47, and starts the A/D conversion operation with respect to an analog input from the next analog input terminal AN2 (S16b). Thereafter, the A/D conversion according to the scan mode is continued by repeating a series of similar steps to S14b, S15b, and S16b until the data transfer by the A/D conversion operation with respect to an analog input from the analog input terminal AN7 is executed.

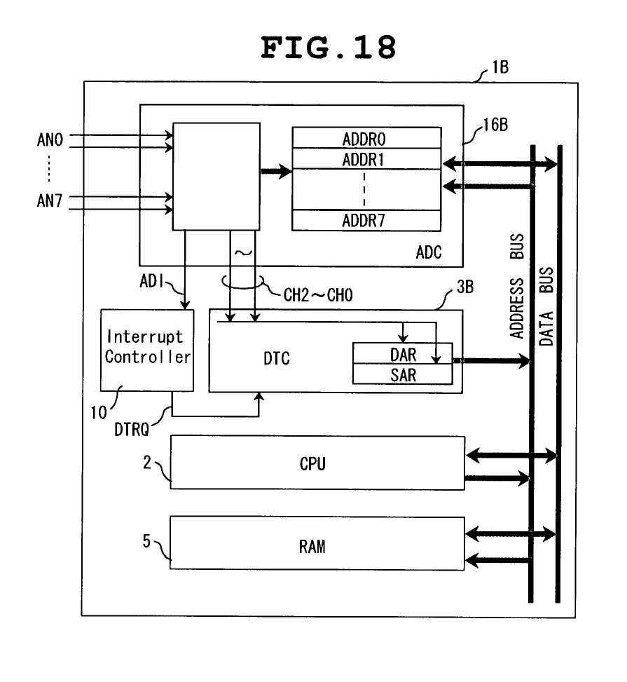

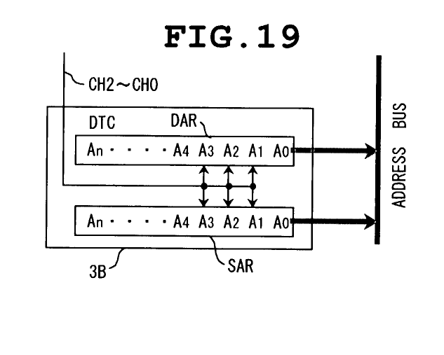

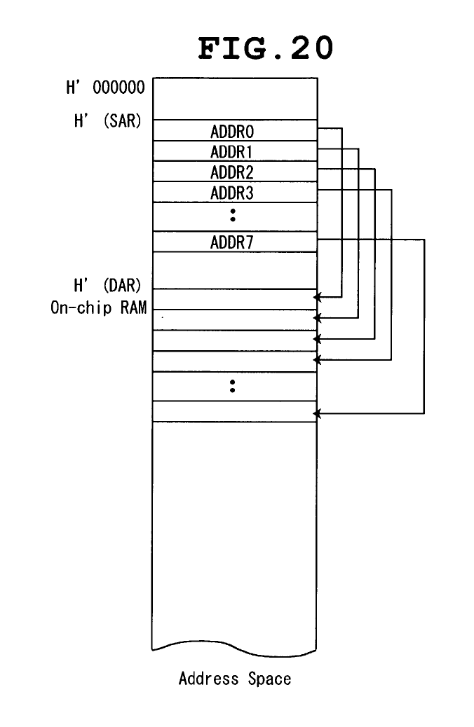

FIG. 18 illustrates a configuration example of another data processor 1B for controlling source and destination addresses using analog input terminal select bit string information CH2 to CH0. The ADC 16B has a plurality of A/D conversion data registers ADDR0 to ADDR7 which can be used according to individual analog input terminals, and the data register to be used is selected based on the analog input terminal select bit string information CH2 to CH0. In the DTC 3B, the low-order three bits of both address registers DAR and SAR can be changed by analog input terminal select bit string information CH2 to CH0, as illustrated in FIG. 19. The data transfer form according to this configuration is illustrated in FIG. 20, the low-order bits of source addresses and destination addresses of the AD conversion data registers ADDR0-ADDR7 are automatically updated based on channel select bit string information CH2 to CH0. With this configuration, the data registers ADDR0 to ADDR7 provided corresponding to individual data input channels can be used as data buffers, so that it is more effective, for example, in the case that the data input intervals from data input channels are short in comparison with the configuration of FIG. 5.

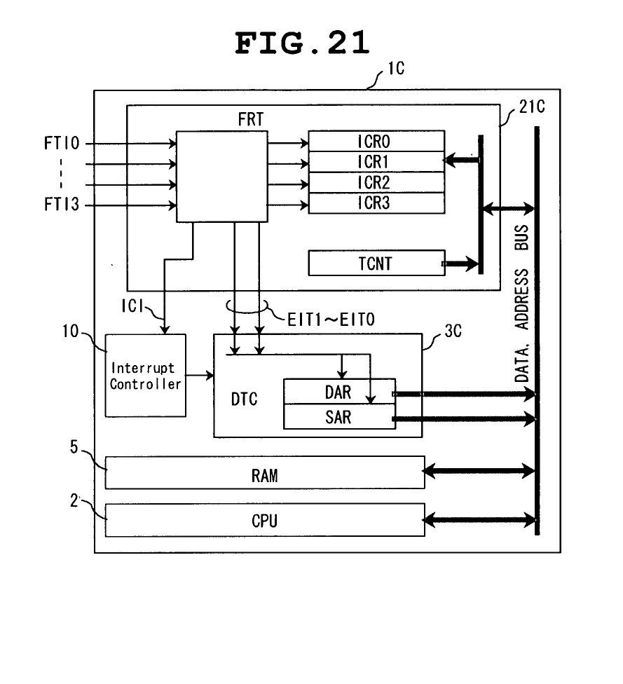

FIG. 21 illustrates a configuration example of still other data processor 1C for controlling source and destination addresses using event input channel identification information EIT1 to EIT0. The FRT 21C has a plurality of input capture registers ICR0 to ICR3 which can be used according to individual events, and the input capture register to be used is selected based on the event input channel identification information EIT1 to EIT0. In the DTC 3C, the low-order two bits of both address registers DAR and SAR can be changed by event input channel identification information EIT1 to EIT0. The data transfer form according to this configuration is the same as the illustrated configuration in FIG. 20, the low-order bits of source addresses of the input capture registers ICR0 to ICR3 and destination addresses on the RAM are automatically updated with transfer requests. With this configuration, the data registers ICR0 to ICR3 provided corresponding to individual event input channels can be used as data buffers, so that it is more effective, for example, in the case that the event input intervals from event input channels are short in comparison with the configuration of FIG. 12.

While the preferred embodiments of our invention have been described specifically, it should be understood that the invention is not limited thereto and various changes and modifications may be made within the scope of the following claims.

As an example of such modifications, the peripheral circuits described herein are limited to an ADC and FRT, may be other peripheral circuits such as a peripheral circuit for communication control such as a SCI, a timer counter, and a watchdog timer.

Although transfer control information for the results of A/D conversion of succeeding channels in a scan mode is not newly loaded from the RAM at each conversion step in the embodiment shown in FIG. 9, the transfer control information may be loaded at every conversion step from the RAM to the DTC, which depends on the difference in data transfer and control methods according to both embodiments.

The invention may be also applied to a configuration with a peripheral circuit comprising a plurality of data registers provided corresponding to the number of data input channels or event input channels, wherein one of those data registers may be shared by two or more data input channels or event channels.

Typical effects according to the invention disclosed herein will be described briefly as follows:

Peripheral circuits such as an ADC are not required to comprise data registers for storing input data processing results corresponding to the number of input terminals, namely in one-to-one correspondence with the input terminals. Additionally, the peripheral circuits such as a FRT are not required to comprise data registers for processing results in response to event inputs according to the number of event input channels. Thus, the number of data register can be reduced in comparison with that of the input channels of peripheral circuits.

The low-order bits of a destination address register are automatically updated based on the identification information from the peripheral circuit, so that the data transfer channels of data transfer control circuits such as direct memory access controllers are not required to be increased with respect to the number of the input channels of the peripheral circuit. It is not necessary to perform a internal transfer processing of data to be transfer-controlled from a memory to a control register each time the peripheral circuit requests data transfer to a data transfer control circuit such as data transfer controllers.

According to the invention, it is possible to suppress an increase in the number of data registers due to an increasing number of the input channels of peripheral circuits and to reduce the overhead associated with data transfer control.

What is claimed is:

1. A data processor comprising:
a central processing unit;
a data transfer control circuit for controlling data transfers under control of said central processing unit; and
a peripheral circuit for requesting data transfers,
wherein said peripheral circuit selects one of input terminals thereof, processes input data from the selected input terminal, requests the transfer of the processing result, and outputs identification information which permits the identification of the selected input terminal, and
said data transfer control circuit has a destination address register (DAR) with its low-order bits variable according to the identification information from said peripheral circuit.

2. The data processor of claim 1, wherein said peripheral circuit comprises a data register shared for storing the processing results of input data.

3. The data processor of claim 1, wherein said peripheral circuit is an analog-to-digital converter having a converter section and a converter control section for converting analog signals to digital form,
said converter section comprising:
a plurality of analog input channels; and
a conversion data register shared for storing the conversion results of input signals from said plurality of analog input channels,
said converter control section requesting the data transfer of the conversion results stored in said conversion data register and outputting code information which permits the identification of analog input channels corresponding to said conversion results.

4. The data processor of claim 3, wherein said converter section further comprises an analog multiplexer for selecting one of said plurality of analog input channels, and converts an analog signal from the analog input channel selected by said analog multiplexer to digital form in a successive approximation procedure.

5. The data processor of claim 4, wherein said converter control section comprises a channel-select register for holding selection information which allows said multiplexer to select one of said plurality of analog input channels, and outputs the selection information held by said channel-select register as said code information.

6. The data processor of claim 5, wherein said converter control section comprises a computing element for incrementing the value of said channel-select register.

7. The data processor of claim 1, wherein said data transfer control circuit is a circuit for controlling data transfers by loading transfer control conditions from a memory in response to data transfer requests, and so arranged that address information set in a destination address register thereof according to the loaded transfer control conditions can be overwritten with said identification information.

8. The data processor of claim 1, wherein said data transfer control circuit is a circuit for controlling data transfers according to transfer control conditions previously set by said central processing unit, and so arranged that address information set in a destination address register as transfer control conditions can be overwritten with said identification information.

9. The data processor of claim 1, further comprising a RAM which can be addressed using address information held by said destination address register.

10. The data processor of claim 9, said data processor is formed into a single semiconductor chip.

11. A data processor comprising:
a central processing unit;
a data transfer control circuit for controlling data transfers under control of said central processing unit; and
a peripheral circuit for requesting data transfers,
wherein said peripheral circuit performs processing in response to the occurrence of an event to be dealt with, requests the transfer of the processing result, and outputs identification information which permits the identification of the event occurrence corresponding to the processing result, and
said data transfer control circuit comprises a destination address register with its low-order bits variable according to identification information from said peripheral circuit.

12. The data processor of claim 11, wherein said peripheral circuit comprises a data register shared for storing the processing results thereof each time said event occurs.

13. The data processor of claim 11, wherein said peripheral circuit has a counter section and a counter control section,
said counter section comprises a counting element and a data register for storing the counted values of said counting element, and
said counter control section stores the counted values of said counting element in said data register in response to the notice of event occurrence from event input channels to be dealt with, requests the transfers of the counted values stored in said data register, and outputs code information which enables the event input channel with such a change to be discriminated from other event input channels as said identification information.

14. The data processor of claim 13, wherein said data register is an input capture register shared by said event input channels.

15. The data processor of claim 11, wherein said data transfer control circuit is a circuit for controlling data transfers by loading transfer control conditions from a memory in response to data transfer requests, and so arranged that address information set in said destination address register can be overwritten with said identification information according to the loaded transfer control conditions.

16. The data processor of claim 11, wherein said data transfer control circuit is a circuit for controlling data transfers according to transfer control conditions previously set by said central processing unit, and so arranged that address information set as transfer control conditions in said destination address register can be overwritten with said identification information.

17. The data processor of claim 11, further comprising a RAM that can be addressed using address information held by said destination address register.

18. The data processor of claim 17, said data processor is formed into a single semiconductor chip.

19. A data processor comprising:
a central processing unit;
a data transfer control circuit for controlling data transfers under control of said central processing unit; and
a peripheral circuit for requesting data transfers,
wherein said peripheral circuit selects one of data input channels thereof, performs a predetermined processing for input data from the selected data input channel, requests the transfer of the processing result, and outputs identification information which permits the identification of the data input channel corresponding to the processing result,
said data transfer control circuit has a source address register and a destination address register with their low-order bits variable according to the identification information from said peripheral circuit.

20. The data processor of claim 19, wherein said peripheral circuit has a plurality of data registers for storing the processing results of input data from said data input channels.

21. A data processor comprising:
a central processing unit;
a data transfer control circuit for controlling data transfers under control of said central processing unit; and
a peripheral circuit for requesting data transfers,
wherein said peripheral circuit performs processing in response to the notice of event occurrence from event input channels to be dealt with, requests the transfer of the processing result, and outputs identification information which permits the identification of the event input channel corresponding to the processing result,
said data transfer control circuit has a source address register and a destination address register with their low-order bits variable according to the identification information from said peripheral circuit.

22. The data processor of claim 21, wherein said peripheral circuit has a plurality of data registers for storing the processing results in response to said event occurrence notice.
